(19) United States
(12) Patent Application Publication
(10) Pub. No.: US 2010/0138018 A1
(43) Pub. Date: Jun. 3, 2010

(54) METHOD FOR PRODUCING A PARTS PROGRAM

(75) Inventors: JOCHEN BRETSCHNEIDER, Esslingen (DE); Ulrich Schleider, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/623,807

(22) Filed: Nov. 23, 2009

(30) Foreign Application Priority Data
Nov. 24, 2008 (EP) 08020399

(51) Int. Cl. G05B 19/4093; G05B 19/4155

(52) U.S. Cl. 700/97; 700/186; 700/180

(57) ABSTRACT

A method and a computer program for producing a parts program are disclosed. The parts program includes control instructions which enable a control device of a machine tool to control movements of a tool, with the steps of reading in movement information relating to movements and machining operations to be performed by the tool, reading in availability information which identifies control subprograms available in the control device for predetermined machining operations to be performed by the tool and, if a control subprogram associated with a predetermined machining operation is available in the control device, generating a control instruction for the parts program from the available control subprograms and the movement information in form of a call for the control subprogram associated with the machining operation. Production of a parts program for a machine tool is thereby simplified.

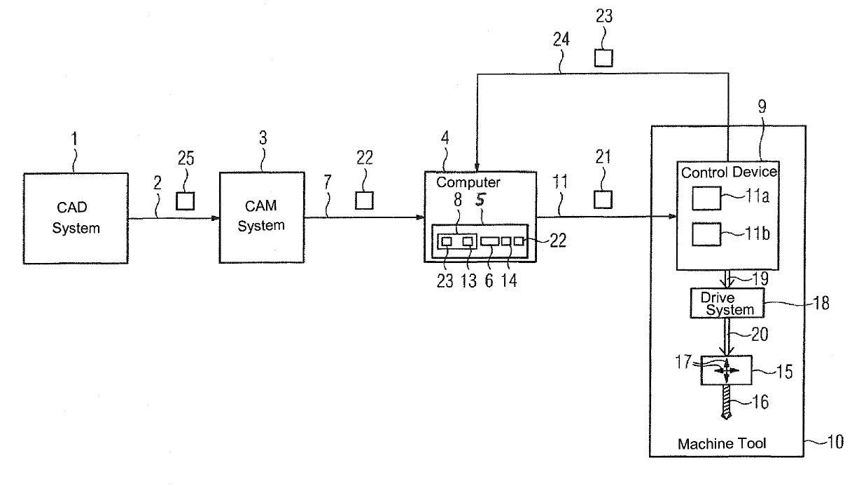

### CROSS-REFERENCES TO RELATED APPLICATIONS

This application claims the priority of European Patent Application, Serial No. EP08020399, filed Nov. 24, 2008, pursuant to 35 U.S.C. 119(a)-(d), the content of which is incorporated herein by reference in its entirety as if fully set forth herein.

### BACKGROUND OF THE INVENTION

The invention relates to a method for producing a parts program. The invention also relates to a computer for carrying out the method.

Nothing in the following discussion of the state of the art is to be construed as an admission of prior art.

Modern machine tools are controlled with the aid of a control device, for example a CNC controller. In this case, the control device controls the movements of a machine element of the machine tool, for example a tool holding apparatus in which a tool has been clamped, using a parts program. In this case, the parts program comprises control instructions which are read in and interpreted by the control device. The control device controls the movement of the machine element and thus the movement of the tool of the machine tool according to the control instructions.

In order to produce a parts program, movement information relating to movements of the tool which need to be carried out is generated in this case by a CAM (Computer Aided Manufacturing) system preferably in a standardized data format and is read in by a downstream post-processor. The post-processor uses the movement information generated by the CAM system, machine data for the machine tool as well as PLC data to generate a parts program, which has been adapted to the respective specific machine tool in which the machining operation is intended to take place, in the form of control instructions adapted to the specific control device of the machine tool. In this manner, the movement information generated by the CAM system preferably in a standardized data format is converted by the post-processor into control instructions which can be read in by the control device and have been adapted to the respective control device.

In this case, the post-processor takes into account the particular machine-specific kinematic conditions of the machine tool, for example geometry, maximum traversing ranges of the drive shafts and maximum speeds of the machine element. These data are in the form of machine data. Furthermore, the post-processor takes into account machine-specific PLC (Programmable Logic Control) functionalities, for example lubrication, tool change, door locking mechanism etc., when generating the control instructions, the PLC functionalities being available to the post-processor in the form of PLC data.

In this case, the movement information generated by the CAM system generally comprises, on the one hand, so-called GOTO instructions containing information relating to movements of the tool which need to be carried out and, on the other hand, additional information relating to the machining operation to be carried out. For example, the movement information may contain the information stating that the preferably subsequent movements of the tool which need to be carried out are a finish-machining operation. During a finish-machining operation, the movements of the tool, for example, must be carried out in such a manner that the best possible surface quality is produced on the workpiece during the machining operation, whereas, for example in contrast to this, the movements of the tool are intended to take place as quickly as possible during a rough-machining operation, in which case the surface quality of the workpiece may be poor and may have dents and elevations, for example.

In this case, in order to carry out particular machining operations in an optimized manner, for example finish-machining and rough-machining, commercially available control devices of machine tools provide optimized control subprograms in the control device, which subprograms, on the one hand, accordingly adapt the control and/or regulating parameters in the control device and in regulating devices downstream of the control device to the specific machining operation, with the result that optimized control and/or regulating parameters are used for the specific machining operation, and, on the other hand, connect or disconnect specific NC (Numerical Control) functionalities, for example a particular movement control functionality. The movement control functionality may involve, for example, activating a functionality in the control device, whereby the machine element and thus the tool are moved in such a manner that no natural vibrations of the machine tool are excited as far as possible and a particularly high level of surface quality of the workpiece thus results when machining the workpiece.

However, this additional information relating to the machining operations inside the movement information generated by the CAM system is not used at all in commercially available post-processors. Furthermore, a commercially available post-processor generally does not have any knowledge at all of which control subprograms which have been optimized for particular machining operations are available in the control device. This results in commercially available post-processors not generating any control subprogram calls for calling the control subprogram associated with the machining operation in the form of a control instruction in automated fashion and the NC functionalities and control and/or regulating parameters optimized for the respective machining operation, for example finish-machining, therefore not being used at all when controlling the movement operation of the tool. If the user nevertheless wishes to use them, he must insert them into the parts program manually. However, not even the user frequently knows which specific control subprograms are actually available, with the result that the control subprograms are often not called in practice and the performance and machining accuracy which can be achieved by the machine tool are therefore not used.

It would therefore be desirable and advantageous to obviate prior art shortcomings and to provide an improved a parts program for a machine tool in a simple manner.

### SUMMARY OF THE INVENTION

According to one aspect of the present invention, a method for producing a parts program having control instructions enabling a control device of a machine tool to control movements of a tool includes the steps of reading in movement information relating to movements and machining operations to be performed by the tool, reading in availability information which identifies control subprograms available in the control device for predetermined machining operations to be performed by the tool and, if a control subprogram associated with a predetermined machining operation is available in the control device, generating a control instruction for the parts program from the available control subprograms and the movement information in form of a call for the control subprogram associated with the machining operation.

According to another aspect of the present invention, a computer has a computer-readable medium with computer program instructions, wherein the program instructions when executed on the computer produce a parts program with control instructions which enable a control device of a machine tool to control movements of a tool. The parts program is produced by reading in movement information relating to movements and machining operations to be performed by the tool, reading in availability information which identifies control subprograms available in the control device for predetermined machining operations to be performed by the tool and, if a control subprogram associated with a predetermined machining operation is available in the control device, generating a control instruction for the parts program from the available control subprograms and the movement information in form of a call for the control subprogram associated with the machining operation.

According to another advantageous feature of the present invention, the availability information may be transmitted by the control device. This ensures that the availability information is always up-to-date and corresponds to the actual conditions in the control device of the machine tool.

According to another advantageous feature of the present invention, a control subprogram may be considered to be an available control subprogram if it has been marked by an operator in the availability information as being available. This ensures that only those control subprograms which have been successfully activated or tested in the machine tool are used to produce the parts program.

According to another advantageous feature of the present invention, the movement information may be generated by a CAM system in a standardized data format since a commercially available CAM system generally generates the movement information in a standardized data format.

According to another advantageous feature of the present invention, the standardized data format may be configured in the form of CLDATA or APT since CLDATA and APT are frequently used standardized data formats.

According to another advantageous feature of the present invention, the availability information may be stored in a file together with machine data for the machine tool, so that only a single file is needed to store the availability information and the machine data.

### BRIEF DESCRIPTION OF THE DRAWING

Other features and advantages of the present invention will be more readily apparent upon reading the following description of currently preferred exemplary embodiments of the invention with reference to the appended drawing, in which the sole FIGURE illustrates schematically in form of a block diagram of the process according to the invention for producing a parts program.

### DETAILED DESCRIPTION OF PREFERRED EMBODIMENTS

The depicted embodiment is to be understood as illustrative of the invention and not as limiting in any way. It should also be understood that the FIGURE is not necessarily to scale and that embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the sole FIGURE, there is shown in form of a schematic block diagram a complete process for producing a parts program. A workpiece to be fabricated is designed and illustrated in a CAD (Computer Aided Design) system 1. In this case, the workpiece has a geometry which is described using geometry data 25, the geometry data for the workpiece generally being in the form of a point cloud which reflects the outer contour of the workpiece. The geometry data 25 for the workpiece are transmitted by the CAD system 1 to a CAM (Computer Aided Manufacturing) system 3, as illustrated by an arrow 2.

The CAM system 3 uses the geometry data 25 for the workpiece and geometry data for a blank from which the workpiece is intended to be milled, for example in the case of milling, to determine the movements of a tool 16 which are needed to mill the blank and thus the movements of a machine element 15 which is in the form of the tool holding apparatus 15, for example, within the scope of the exemplary embodiment. In this case, a tool 16 which is in the form of a milling cutter within the scope of the exemplary embodiment has been clamped into the tool holding apparatus 15. The tool holding apparatus 15 and thus the tool 16 can be moved in this case in different directions 17 within the scope of the available kinematics of the machine tool 10. In this case, the movements of the machine element 15 are controlled by a control device 9 which is in the form of a CNC controller within the scope of the exemplary embodiment. For this purpose, the control device 9 generates, in an equidistant timing clock cycle, desired values as desired control values for a drive system 18 which moves the tool holding apparatus 15, which is illustrated by an arrow 20. The desired values are transmitted by the control device 9 to the drive system 18, which is illustrated by an arrow 19 in the FIGURE. In this case, the drive system 18 essentially comprises the regulating devices, power converters, motors and gear mechanisms needed to drive the machine element 15. In this case, the control device 9 controls the movement of the tool 16 using a parts program 21 having control instructions which are used by the control device 9 to control the machine tool 10. On the output side, the CAM system 3 uses the geometry data for the workpiece which have been transmitted by the CAD system 1 and the geometry data for the blank to generate movement information 22 relating to the movements of the tool 16 which need to be carried out in order to produce the workpiece from the blank. In this case, the movement information 22 relating to the movements of the tool 16 which need to be carried out is generally generated by the CAM system 3 in a standardized data format, for example CLDATA or APT. In this case, the movement information comprises information relating to movements of the tool which need to be carried out, generally in the form of position information relating to the positions which the so-called tool center point of the tool 16 must assume in succession and thus the positions which the tool 16 must assume in succession and must consequently be moved accordingly in order to produce, in particular mill, the desired workpiece from the blank.

The movement information relating to the movements to be carried out is generally essentially in the form of so-called standardized GOTO instructions in this case. However, in addition to the information relating to the movements of the tool which need to be carried out, the movement information also comprises information relating to the machining operation which is carried out with the movements to be carried out. For example, some movements of the tool may belong to a finish-machining operation in which a high level of surface quality of the workpiece is intended to be achieved, and other movements may belong to a rough-machining operation in which a large amount of material is intended to be removed from the workpiece as quickly as possible without taking into account the resultant surface quality of the workpiece.

The movement information 22 is transmitted to a computer 4 (see arrow 7) and is read in by a computer 4 on which a computer program 14 for producing the parts program runs, the computer 4 in conjunction with the computer program 14 running on it technically also being referred to as a post-processor.

A commercially available post-processor generates a parts program 21 from the movement information 22 generated by the CAM system using machine data 13 for the machine tool 10 and PLC (Programmable Logic Control) data 6 for the machine tool 10, which parts program is transmitted to the control device 9 for controlling the movement of the tool, which is illustrated by an arrow 11 in the FIGURE. The machine data comprise information, for example information relating to the kinematics of the machine tool, the drive system of the machine tool, permissible traversing ranges of the machine element and, for example, permissible maximum speeds, maximum acceleration and maximum jerks with which the machine element and thus the tool can be moved. The PLC data comprise, for example, information relating to a tool changer which is available in the machine tool if present, information relating to the door locking mechanism of the machine tool as well as information relating to the lubrication of the machine tool and information relating to the available PLC instructions of the control device etc. The practice of generating a parts program 21 using the movement information 22, the machine data 13 and the PLC data 6 in order to produce a parts program 21 using a post-processor is prior art.

However, the information contained in the movement information 22 and relating to the machining operations is not automatically used by the post-processor in the prior art to produce the parts program 21.

In order to achieve optimum machining results, the control device 9 has control subprograms which are generally concomitantly supplied by the manufacturer of the control device. The control subprograms ensure that, when they are called, control and/or regulating parameters which have been optimized for the machining operation associated with the respective control subprogram are used in the control device and/or in regulating devices (for example within the drive system 18) downstream of the control device to guide the movement of the tool in an optimized manner and/or particular NC functionalities, for example a special implementation of the movements which, on account of the special jerk with which the movements of the tool are carried out, do not excite any natural vibrations of the machine and thus make it possible to achieve a particularly good level of surface quality of the workpiece during the machining operation, are activated. Furthermore, particular settings in the control device, for example the timing clock cycle with which the desired values are generated by the control device 9 and are transmitted to the drive system 18, can also be changed using the control subprograms and optimized movement courses of the tool can thus be achieved for the respective machining operation.

Within the scope of the exemplary embodiment, the control device 9 has a control subprogram 11a for the finish-machining operation and a control subprogram 11b for the rough-machining operation. When the control subprogram 11a is called, the control device 9 ensures that, for example, subsequent control instructions in the parts program 21 are carried out using the parameters defined in the control subprogram 11a and NC functionalities. When the control subprogram 11b is called, the control device 9 accordingly ensures that, for example, subsequent control instructions in the parts program are carried out using the parameters defined in the control subprogram 11b and NC functionalities.

The control subprograms which are contained in the control device 9 and have been previously implemented, for example, by the manufacturer of the control device 9 or the machine tool 10 are available in the control device. The information (called availability information below) regarding the control subprograms which are available in the control device is transmitted by the control device 9 to the post-processor, that is to say the computer 4, which is illustrated by an arrow 24 in the FIGURE. In this case, the availability information 23 may be, for example, in the form of a list which preferably lists all control subprograms which have been implemented.

However, the control subprograms which have been implemented must also often be tested, for example when starting up the machine tool, by an operator who may be the start-up engineer, for example, and must be considered to be reliable. Within the scope of an advantageous embodiment of the invention, only those control subprograms which have been tested in this manner by the operator and have been expressly marked by the operator as being available within the availability information are considered to be available control subprograms. In this case, the availability information may be, for example, in the form of a list in which all implemented control subprograms are preferably listed and the operator marks the corresponding control subprogram as being available, for example in a corresponding column of the list, by writing a “1” or a “0” behind the corresponding control subprogram. A “1” marks the control subprogram as being available, whereas a “0” marks the control subprogram as not being available. As already stated, the control subprograms tested by the operator are preferably marked by the operator as being available control subprograms in this case. As already stated, the availability information 23 which is in the form of a list in the exemplary embodiment and specifies the control subprograms which are available in the control device 9 of the machine tool 10 is transmitted, according to the invention, by the control device 9 to the post-processor, that is to say the computer 4, which is illustrated by an arrow 24 in the FIGURE. According to the invention, the availability information 23 and the information which is included as part of the movement information 22 and relates to the machining operations are now concomitantly used by the post-processor to produce the parts program 21. According to the invention, in order to produce the parts program 21, the control instructions in the parts program are generated in this case using the available control subprograms and the movement information in such a manner that, if a control subprogram associated with a machining operation to be carried out is available in the control device for the machining operation, a control subprogram call for calling the control subprogram associated with the machining operation is generated in the form of a control instruction.

If it is stated, for example within the movement information 22, that subsequent movements to be carried out belong to the finish-machining operation, that is to say are part of a finish-machining operation, the post-processor generates, as a control instruction, a control subprogram call for calling the “finish-machining” control subprogram 11a associated with the finish-machining operation and writes it to the parts program as part of the parts program. Such a control instruction can then be “Cycle832 (finish-machining)”, for example. Subsequent control instructions generated by the post-processor are then executed by the control device and/or by regulating devices downstream of the control device 9 using the parameters defined in the “finish-machining” control subprogram and NC functionalities when moving the tool.

If it is stated, for example within the movement information 22, that subsequent movements to be carried out belong to the rough-machining operation, that is to say are part of a rough-machining operation, the post-processor generates, as a control instruction, a control subprogram call for calling the “rough-machining” control subprogram 11b associated with the rough-machining operation and writes it to the parts program as part of the parts program. Such a control instruction can then be “Cycle832 (rough-machining)”, for example. Subsequent control instructions generated by the post-processor are then executed by the control device and/or by regulating devices downstream of the control device 9 using the parameters defined in the “rough-machining” control subprogram and NC functionalities when moving the tool.

Within the scope of the exemplary embodiment, the computer 4 has a mass memory 5 which may be in the form of a hard disk, for example. The mass memory 5 stores the computer program 14, in which case, when the computer program is called by a user, for example, the computer program 14 is loaded into a RAM memory of the computer 4 and is executed there, with the result that the method according to the invention can be carried out by the computer when the computer program 14 is called. In this case, the machine data 13 and the PLC data 6 are preferably likewise stored in the mass memory 5. Furthermore, the availability information 23 is preferably likewise stored in the mass memory 5, the availability information 23 and the machine data 13 preferably being stored inside a common file 8. In this case, the availability information 23 may be produced in a data structure which corresponds to the data structure of the machine data 13, with the result that they can be read in by the post-processor in a simple manner. Furthermore, the movement information 22 is also stored in the mass memory 5.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for producing a parts program having control instructions enabling a control device of a machine tool to control movements of a tool, comprising the steps of:
reading in movement information relating to movements and machining operations to be performed by the tool;
reading in availability information which identifies control subprograms available in the control device for predetermined machining operations to be performed by the tool; and
if a control subprogram associated with a predetermined machining operation is available in the control device, generating a control instruction for the parts program from the available control subprograms and the movement information in form of a call for the control subprogram associated with the machining operation.

2. The method of claim 1, wherein the availability information is transmitted by the control device.

3. The method of claim 1, further comprising the step of allowing an operator to mark in the availability information a control subprogram as being available, whereby the marked control subprogram becomes available in the control device for predetermined machining operations to be performed by the tool.

4. The method of claim 1, wherein the movement information is generated by a CAM system in a standardized data format.

5. The method of claim 4, wherein the standardized data format is implemented as CLDATA or APT.

6. The method of claim 1, wherein the availability information is stored in a file together with machine data for the machine tool.

7. The method of claim 3, wherein the marked availability information is stored in a file together with machine data for the machine tool.

8. A computer having a computer-readable medium with computer program instructions, wherein the program instructions when executed on the computer produce a parts program with control instructions which enable a control device of a machine tool to control movements of a tool, wherein the parts program is produced by the following steps:
reading in movement information relating to movements and machining operations to be performed by the tool;
reading in availability information which identifies control subprograms available in the control device for predetermined machining operations to be performed by the tool; and
if a control subprogram associated with a predetermined machining operation is available in the control device, generating a control instruction for the parts program from the available control subprograms and the movement information in form of a call for the control subprogram associated with the machining operation.
